(19) United States
(12) Patent Application Publication
(10) Pub. No.: US 2021/0319533 A1
(43) Pub. Date: Oct. 14, 2021

(54) APPARATUS, METHOD AND SYSTEM FOR GENERATING A FOVEATED IMAGE

(71) Applicant: Electronics and Telecommunications Research Institute, Daejeon (KR)

(72) Inventors: Ki Hong CHOI, Daejeon (KR); Joong Ki PARK, Daejeon (KR); Han Ju YEOM, Sejong-si (KR); Kee Hoon HONG, Daejeon (KR)

(73) Assignee: Electronics and Telecommunications Research Institute, Daejeon (KR)

(21) Appl. No.: 17/224,478

(22) Filed: Apr. 7, 2021

(30) Foreign Application Priority Data
Apr. 8, 2020 (KR) 10-2020-0042784
Mar. 24, 2021 (KR) 10-2021-0037780

(51) Int. Cl. G06T 3/40; G06T 7/50; G03H 1/04

(52) U.S. Cl. CPC G06T 3/40; G03H 2001/0452; G03H 1/0443; G06T 7/50

(57) ABSTRACT

The present disclosure relates to an apparatus, method and system for generating a foveated image. According to the present disclosure, an apparatus for generating a foveated image, the apparatus may comprise a communicator configured to transmit and receive a signal and a processor configured to control the communicator, wherein the processor distinguishes objects comprised in a hologram, which is generated for a front field of view by using input light, selects an object to be targeted among the distinguished objects, and generates a foveated image by using depth information of the targeted object.

### CROSS REFERENCE TO RELATED APPLICATION

The present application claims priority to Korean Provisional Applications No. 10-2020-0042784, filed Apr. 8, 2020, and No. 10-2021-0037780, filed Mar. 24, 2021, the entire contents of which are incorporated herein for all purposes by this reference.

### BACKGROUND OF THE INVENTION

### Field of the Invention

The present disclosure relates to an apparatus, method and system for generating a foveated image.

### Description of the Related Art

When a person looks at a thing, the field of view includes a central object and the periphery as background. Unlike the central object on which the view is focused, the periphery, which is not focused, remains as a blurred part of the view. Recently, a technology of generating a foveated image was developed which applies such a physiological characteristic shown in human eyes to virtual reality in order to generate a three-dimensional image.

The technology of generating a foveated image means an imaging system that imitates human visual perception to image a central part in high resolution and a periphery in low resolution. FIG. 1 is a view related to an example of a foveated image. According to a technology of generating a foveated image, a part on which an eye focuses is implemented in high resolution and the remaining background is processed by low resolution so that graphics throughput may be reduced and data may be processed faster. Recently, a technology of outputting an image in high resolution only for a region of interest (ROI) rather than utilizing data of every pixel, while using a circuit of an existing image sensor to generate a foveated image, was proposed.

Also, a mechanical optical system, which outputs both an image with a wide field of view and an image with a precise field of view and implements a precise image for a ROI by controlling a rotation angle of a reflector, is proposed.

### SUMMARY

The present disclosure provides an apparatus, method and system for generating a foveated image.

According to the present disclosure, an apparatus for generating a foveated image, the apparatus may comprise a communicator configured to transmit and receive a signal and a processor configured to control the communicator, wherein the processor distinguishes objects comprised in a hologram, which is generated for a front field of view by using input light, selects an object to be targeted among the distinguished objects, and generates a foveated image by using depth information of the targeted object.

According to the present disclosure, a method for generating a foveated image, the method may comprise distinguishing objects comprised in a hologram for a front field of view, which is generated by using input light, measuring, by selecting an object to be targeted among the distinguished objects, depth information of the selected object and generating a foveated image based on the measured depth information and the generated hologram.

According to the present disclosure, a system for generating a foveated image, the system may comprise a hologram generator configured to generate a hologram for a front field of view based on input light, a precision depth information measuring apparatus configured to measure depth information of an object to be targeted comprised in the hologram and a foveated image generator configured to distinguish objects comprised in the generated hologram, to select the object to be targeted for which the depth information is to be measured, and to generate a foveated image by using depth information of the selected object.

An object of the present disclosure is to provide an efficient apparatus, method and system for generating a foveated image.

An object of the present disclosure is to generate a foveated image in which color information of a wide field of view is recorded.

An object of the present disclosure is to generate a foveated image for immediately aiming at and detecting an object of interest.

Other objects and advantages of the present disclosure will become apparent from the description below and will be clearly understood through embodiments of the present disclosure. Also, it will be easily understood that the objects and advantages of the present disclosure may be realized by means of the appended claims and a combination thereof.

According to the present disclosure, an efficient apparatus, method and system for generating a foveated image may be obtained.

According to the present disclosure, an object of the present disclosure may generate a foveated image in which color information of a wide view is recorded.

According to the present disclosure, a foveated image may be generated for immediately aiming at and detecting an object of interest.

According to the present disclosure, a foveated image may be generated which may be used in virtual reality (VR), augmented reality (AR), autonomous vehicles, and other areas that need to analyze spatial optical information of periphery.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a view related to an example of a foveated image.

FIG. 2 as a view related to an example of a dual depth measurement sensor applicable to the present disclosure.

FIG. 3 is a view related to a self-interference digital holography system architecture applicable to the present disclosure.

FIG. 4 is a view related to a configuration of a foveated image generation system according to an embodiment of the present disclosure.

FIG. 5 is a view related to a configuration of a foveated image generation system including a LiDAR aiming system according to an embodiment of the present disclosure.

FIG. 6 is a view related to a flowchart of generating a foveated image in a foveated image generation system including a LiDAR aiming system according to an embodiment of the present disclosure.

FIG. 7 is a view related to a method for generating a foveated image according to an embodiment of the present disclosure.

FIG. 8 is a view related to a foveated image generator according to an embodiment of the present disclosure.

FIG. 9 is a view related to a foveated image generation system according to another embodiment of the present disclosure.

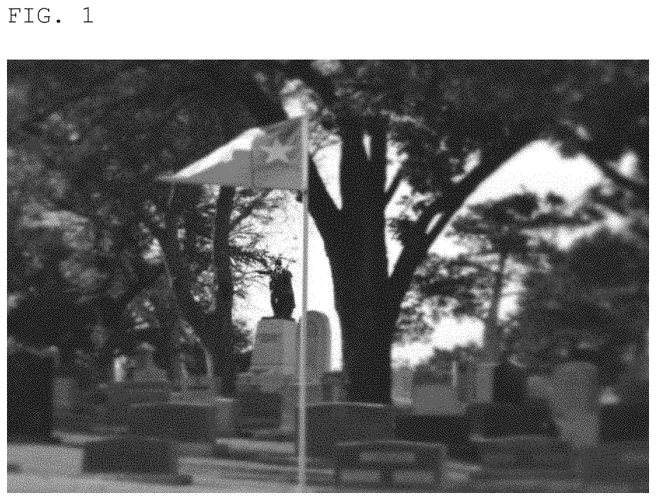

### DETAILED DESCRIPTION

Hereinafter, embodiments of the present disclosure will be described in detail with reference to the accompanying drawings, which will be easily implemented by those skilled in the art. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. In addition, parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present invention. Also, embodiments that include other components in addition to the components described in the various embodiments are also included in the scope of the present disclosure.

Meanwhile, in the description of the present disclosure, the terms “hologram record”, “hologram generation” and “hologram reconstructing” may be used interchangeably.

Meanwhile, in the description of the present disclosure, a system may be expressed as an apparatus, and an apparatus may be expressed as a system. That is, the present disclosure is not limited to the expression of system/apparatus.

Meanwhile, the terms “wavefront separator” and “wavefront modulator” may be used interchangeably.

Hereinafter, various embodiments of the present disclosure will be described with reference to the accompanying drawings.

The present disclosure relates to a technique of generating a foveated image and, more particularly, to a technique of generating an image in which only a necessary region maintains a maximum resolution and the background region is flexibly expressed in a low resolution. Herein, further detailed measurement of depth may be required for the necessary region of the image in which the maximum resolution needs to be maintained.

For further detailed measurement of depth, a time-of-flight (ToF) camera, laser-based light detection and ranging (LiDAR) and other sensors for obtaining a high-precision depth map have already been proposed.

LiDAR is a laser-based depth sensing method that recognizes a depth to detect an object in a front field of view by sending out pulsed light and measuring the time for the reflected light to return. This includes radar, time-of-flight (ToF) and other depth recognition methods based on pulsed light irradiation. In the case of a method using laser, depth recognition and each resolving power are excellent. However, as a front field of view should be scanned at high speed, it is difficult to use at a wide angle of view in real time. It is utilized for long-range measurement not for short-range measurement and is mainly installed on the front of an autonomous vehicle to measure a distance between vehicles.

In the case of a ToF camera, as a pulsed LED is used, an angle of view is wider than the one in the laser-based LiDAR technology, but low power of pulsed light reduces the measurement range within only a few meters. Radar is a technology specialized in detecting a wide range by means of radio waves, and its detection range is shorter than LiDAR using laser.

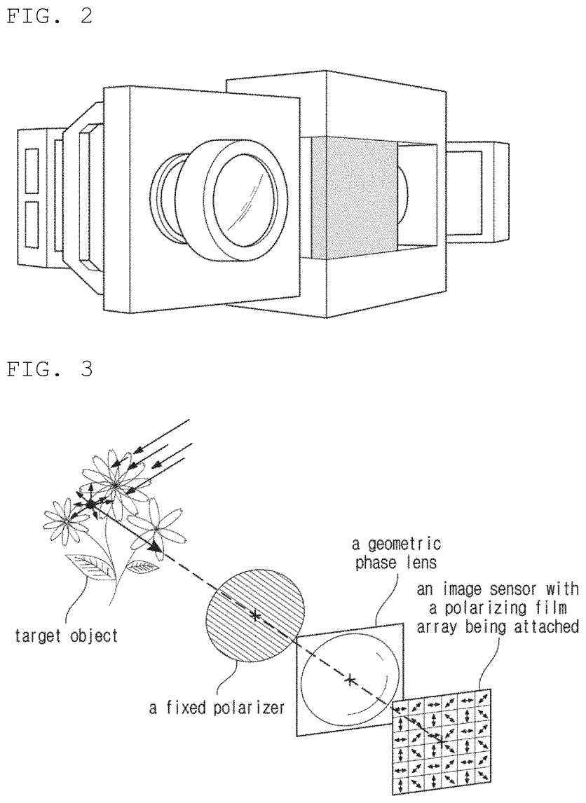

FIG. 2 is a view related to an example of a dual depth measurement sensor combining low-precision radio wave radar and a high-precision radar applicable to the present disclosure. released a dual depth sensor that combines low-precision radar with a wide field of view and high-precision LiDAR with a narrow field of view.

However, the above sensor is not capable of measuring a wide field of view in a short time, and as it is not capable of knowing color information, a separate imaging camera is needed.

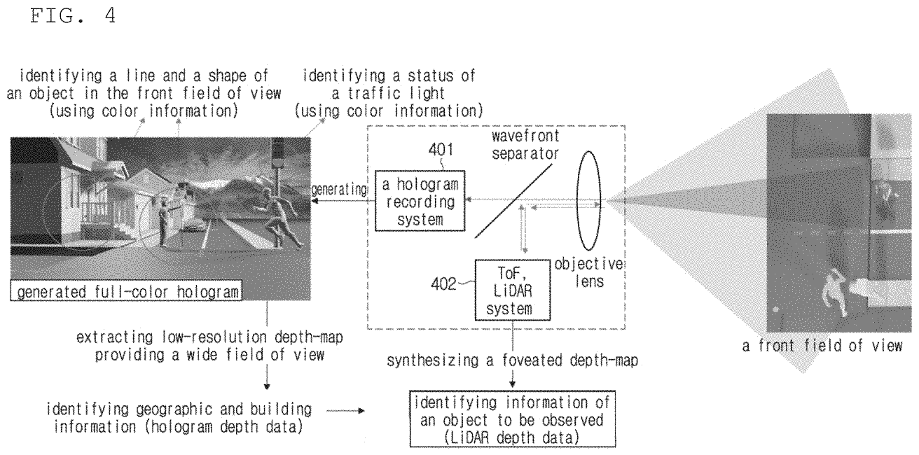

Meanwhile, unlike a sensor for obtaining a high-precision depth map with a narrow field of view including FIG. 2, a technique capable of obtaining a low-precision depth map with a wide field of view is also proposed, and the self-interference digital holography technique of FIG. 3 is a representative technique.

The self-interference digital holography system of FIG. 3 may consist of an object to be shot, a fixed polarizer, a geometric phase lens, and an image sensor with a polarizing film array being attached.

Digital holography is a technique capable of obtaining complex optical information of an optical field composed of an amplitude and a phase by using interference of light, and self-interference holography, in particular, is a technique capable of obtaining a hologram from a general light source without using laser. Three-dimensional optical information may be recorded, stored and processed on a two-dimensional plane through the self-interference holography technique.

An interference pattern is obtained by a self-interference method that divides an incident wave emitted and reflected from an object according to spatial or polarization states. An interference pattern is formed on an image sensor when an incident wave is modulated to wavefronts with different values of curvature by being affected by a wavefront modulator and is propagated. As the interference herein occurs between twin light waves that originate from light starting from the same space-time, it is free from the condition of a light source. Accordingly, shooting is possible under a fluorescent light, a light bulb, LED or natural light condition.

More specifically, FIG. 3 shows a structure of self-interference digital holography that uses a geometric phase lens as a wavefront modulator. As it inherently includes three-dimensional optical information, it may be reconstructed, that is, generated according to a depth interval, and depth information of space may be extracted through various algorithms. However, as the resolution of depth is inversely proportional to the distance of an object, the remoter the object the sparser the distinction of depth.

Although a self-interference digital holography system is inherently capable of recording and processing RGB data and depth information of a wide field of view, the precision of depth resolution decreases as the distance of an object increases.

Accordingly, in order to maximize the advantages of the two techniques and to make up for disadvantages, the present disclosure proposes a technique capable of generating a foveated depth map, which obtains high-precision depth information for a partial field of view and rough depth information for a periphery, and also of obtaining tricolor brightness information that enables a shape, a color and a feature of a front field of view.

According to the present disclosure, it is possible to detect a scene with a wide field of view by using a holography technique, and it is possible to immediately aim at and precisely detect a dangerous object by means of a ToF camera and LiDAR sensing that are attached to a rotating instrument.

FIG. 4 is a view showing a configuration and an information processing process of a foveated image generation system according to an embodiment of the present disclosure.

In one embodiment, a foveated image generation system may include a hologram recording system 401 and a ToF camera and LiDAR system 402.

When light for a front field of view is incident on an objective lens, two optical paths that are separated through a wavefront separator may be used for the hologram recording system 401 and the ToF camera and LiDAR system 402 respectively. Alternatively, it may be implemented as a multi-aperture system with no wavefront separator, but the present disclosure is not limited thereto.

The hologram recording system 410 may generate a hologram for a front field of view based on input light. A hologram recording system may generate a hologram in ways including self-interference digital holography, and a geometric phase lens may be applied. When a hologram is generated, color information (e.g., RGB) and a depth map, which represents a depth distribution for an entire field of view, may be extracted from the hologram. Color information (e.g., RGB data) of a hologram may be used to identify the appearance of necessary information like a line, a shape of a pedestrian, and a status of a traffic light, which are included in a front field of view, and to distinguish an object, and depth-map data may be used to find an overall depth distribution of an entire field of view. Herein, a hologram generated by the hologram recording system 401 may be a low-resolution hologram providing a wide field of view (angle of view).

Meanwhile, when a foveated image generation system of the present disclosure is used for autonomous driving or driving assistance system of a vehicle or in a CCTV for security, higher-precision detection may be needed for a vehicle or a pedestrian that is moving fast towards an object (e.g, vehicle) including the foveated image generation system of the present disclosure. However, as a hologram generated by the hologram recording system 401 may be a relatively low-resolution hologram, precise depth measurement may be needed for a targeted object (or targeted objects) included in the generated hologram. When the targeted object is at the center of the field of view of the hologram, it may be necessary to perform more precise depth measurement for the center of the field of view through the ToF camera and LiDAR system 402.

The ToF camera and LiDAR system 402 may obtain more precise depth information of an object to be observed based on a hologram that is generated by a hologram recording system. The system 402 may detect precise depth information using light that is incident through an optical path separated by a wavefront separator, but this is one embodiment and the present disclosure is not limited thereto. When depth information of an object to be observed is obtained, a ToF camera and LiDAR system may generate foveated depth information (depth-map) based on the depth information. Foveated depth information (depth-map) may be generated based on a hologram generated by the hologram recording system 401 and depth information obtained by a ToF camera and LiDAR system, but the present disclosure is not limited thereto.

Meanwhile, the foveated image generation system of FIG. 4 is expressed as a system for convenience's sake but may be configured as an apparatus. This is applied equally to the hologram recording system or the ToF camera and LiDAR system that are mentioned above.

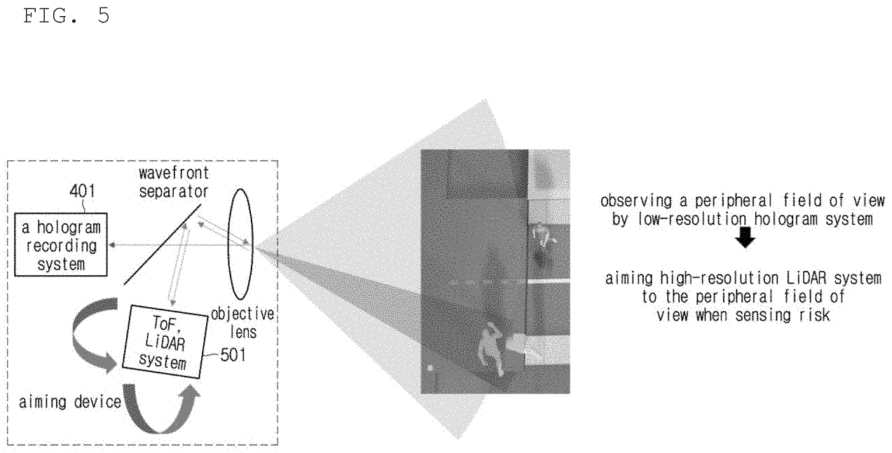

Meanwhile, among objects that are included in a hologram for a front field of view generated by the hologram recording system 401, there may be an object (a targeted object) that is not included at the center of the field of view but is detected to move quickly and thus is considered to be worthy of observation. It may be determined that such an object has a risk of collision. For the targeted object, a ToF camera and LiDAR system may have to perform precision aiming, which will be described in further detail with reference to FIG. 5.

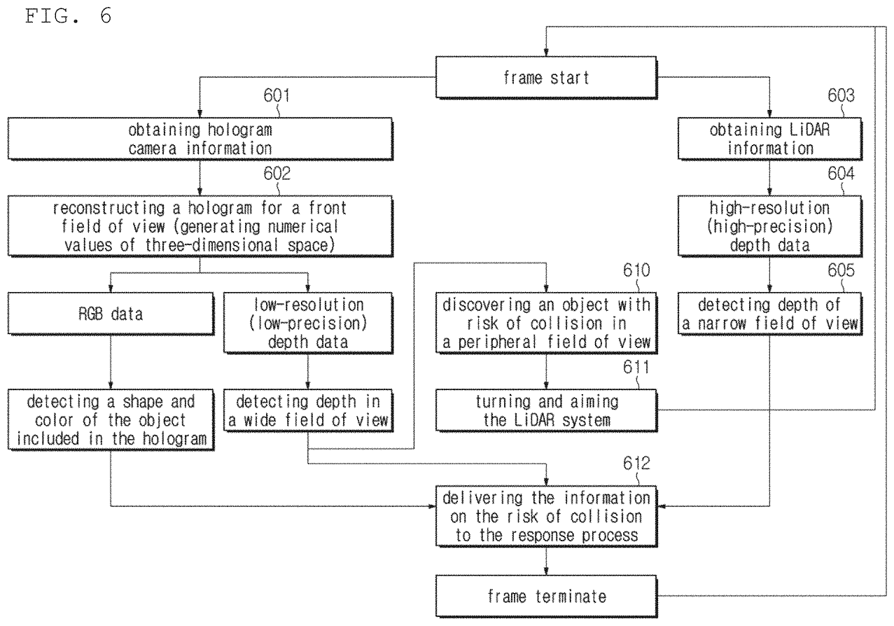

FIG. 5 is a view related to a configuration of a foveated image generation system including a LiDAR aiming system according to an embodiment of the present disclosure, and FIG. 6 is a view related to a flowchart of generating a foveated image in a foveated image generation system including a LiDAR aiming system according to an embodiment of the present disclosure.

In one embodiment, a foveated image generation system including a LiDAR aiming system may include the hologram recording system 401 and a ToF camera and LiDAR system 501. A LiDAR aiming system may be included in the ToF camera and LiDAR system 501. Meanwhile, a process, in which the hologram recording system 401 generates a hologram, and the generated hologram may be the same as described in FIG. 4, and a method of obtaining foveated depth information by the ToF camera and LiDAR system 501 except LiDAR's aiming method may be the same as described above with reference to FIG. 4. However, this is an assumption for clarity of explanation, and the present disclosure is not limited thereto.

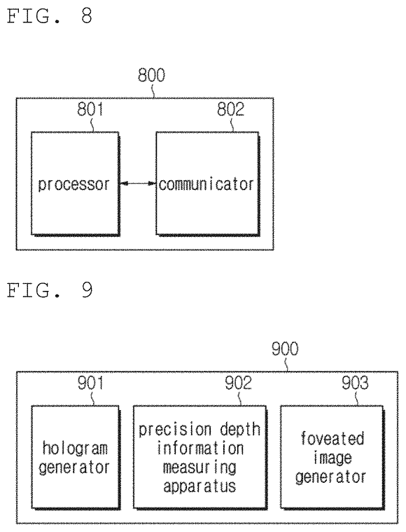

Meanwhile, the flowchart of FIG. 6 for generating a foveated image is described based on the foveated image generation system of FIG. 5. However, this is for clarity of explanation. The flowchart may be implemented based on a foveated image generator. It may be based on a foveated image generator of FIG. 8 or a foveated image generation system of FIG. 9. However, the present disclosure is not limited thereto.

As mentioned above, a foveated image generation system may obtain (601) hologram camera information to generate a hologram for a front field of view by using input light.

Based on the obtained hologram camera information, a hologram for a front field of view may be generated by reconstructing (602), that is, generating numerical values of three-dimensional space. Based on color information (e.g., RGB data) of a generated hologram, an object may be distinguished by detecting a shape and color of the object included in the hologram, and depth detection in a wide field of view may be performed based on low-precision depth data (e.g., a depth map) included in the hologram. This is the same as mentioned above.

Herein, when an object with risk of collision is discovered (610) in a peripheral field of view outside a central field of view within a hologram, a configuration with a rotating device attached to LiDAR may be available to immediately observe an object with risk of collision that suddenly appears in a peripheral field of view outside the center of a front field of view. In a normal situation, a low-resolution hologram is generated for an object that is captured in a periphery of a front field of view so that depth resolution is coarse. However, when an object is sensed which drastically changes its depth or size, depth may be precisely detected and the risk of collision may be sensed by turning and aiming (611) a field of view (FOV) of a high-resolution LiDAR system at a corresponding region. Herein, the high-resolution LiDAR system may include the ToF camera and LiDAR system 402 of FIG. 4 including a LiDAR system and a ToF camera.

By using a high-resolution LiDAR system that is aimed, LiDAR information of a targeted object may be obtained (603). In one embodiment, obtained information may include pulsed optical information through the aiming of a ToF camera and LiDAR and may be information that is obtained from ToF depth recognition. In addition, obtained information may include high-precision depth data 604, which maybe information including a depth distribution of a targeted region. Whether or not a response process for an object with risk of collision is needed may be determined by detecting (605) depth of a narrow field of view based on the obtained high-precision depth data 604. When it is determined that a response process for an object with risk of collision is needed, the information on the risk of collision may be delivered (612) to the response process.

Meanwhile, the foveated image generation system of FIG. 5 is expressed as a system for convenience's sake but may be configured as an apparatus. This is applied equally to the hologram recording system or the ToF camera and LiDAR system that are mentioned above.

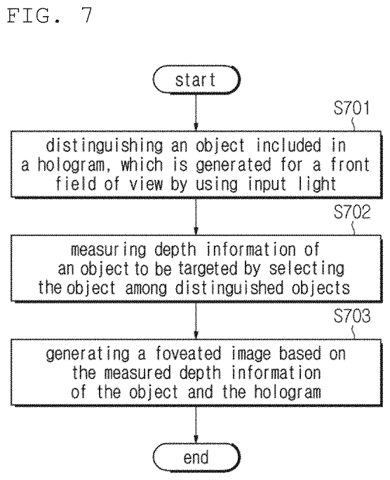

FIG. 7 is a view related to a method for generating a foveated image according to an embodiment of the present disclosure.

In one embodiment, a method for generating a foveated image may be implemented by a foveated image generator and a foveated image generation system. A foveated image generator may include an apparatus of FIG. 8, and a foveated image generation system may include a system of FIG. 4, FIG. 5 and FIG. 9.

In one embodiment, first, in order to generate a foveated image, an object included in a hologram, which is generated for a front field of view by using input light, may be distinguished (S701). In one embodiment, input light may be separated into two optical paths through a wavefront separator and may be used to generate a hologram and to measure the following depth information (S702). A hologram for a front field of view may be generated by the above-described hologram recording system. A hologram may be generated based on complex optical information that is obtained by a single-camera optical system. Also, a generated hologram may be a hologram that is generated in such a way as self-interference digital holography, and may be generated by applying a geometric phase lens. Meanwhile, an object included in a hologram may be distinguished by using the color information and depth information of the hologram. This may be the same as described above. Meanwhile, a hologram may be iteratively generated at a predetermined time interval.

Next, by selecting a targeted object (or targeted objects) among distinguished objects, depth information of the targeted object may be measured (S702). The targeted object may exist in the central field of view of a generated hologram, that is, in a central region. Alternatively, they may exist in a peripheral field of view, that is, outside a central field of view of a generated hologram. In addition, they may be the object that change depth information or size. For example, the selected object (the targeted object) may include the object that change in at least one of depth and size in an iteratively generated hologram. It may be determined that the selected object has a risk of collision. This may be the same as described above.

Based on depth information of a measured object and a generated hologram, a foveated image may be generated (S703). Depth information of the object may be measured through a laser-based LiDAR and ToF camera. In one embodiment, when the object exists in a peripheral field of view of a generated hologram, a field of view of LiDAR may be adjusted so that it may be turned and aimed at the targeted object(s). This may be the same as mentioned above.

Meanwhile, as the method of FIG. 7 for generating a foveated image is an embodiment, depending on the situation, some steps may be excluded, an order of steps may be changed, or another step including the generating of a hologram may be further included. However, the present disclosure is not limited thereto.

FIG. 8 is a view related to a foveated image generator according to an embodiment of the present disclosure.

In one embodiment, the foveated image generator of FIG. 8 may be included in the foveated image generation system of FIG. 4 and FIG. 5 and may implement the method for generating a foveated image in FIG. 6 and FIG. 7.

In addition, a foveated image generator may provide another function like generating a hologram itself or performing precise detection of depth information for a specific object by directly using a LiDAR and ToF camera. That is, a hologram recording apparatus (or system) or a ToF camera and LiDAR system (or apparatus) may be included in a foveated image generator. However, the present disclosure is not limited thereto.

In one embodiment, a foveated image generator 800 may include a communicator 801 for transmitting and receiving a signal and a processor 802 for controlling the communicator.

The processor 802 may distinguish objects included in a hologram, which is generated for a front field of view by using input light, select an object to be targeted among the distinguished objects, and generate a foveated image by using depth information of the selected object. Herein, input light may be separated into two optical paths through a wavefront separator and may be used to generate a hologram. A generated hologram may be a hologram that is generated in such a way as self-interference digital holography, and may be generated by applying a geometric phase lens. In addition, a generated hologram may be used to measure depth information of some selected objects. Meanwhile, the targeted object(s) may exist in a central region of a generated hologram. In addition, depth information of the selected object(s) may be measured through a laser-based LiDAR and ToF camera. In one embodiment, a field of view of LiDAR may be adjusted to a region including the selected object(s). A generated hologram may be based on complex optical information that is obtained by a single-camera optical system. An object included in a generated hologram may be distinguished based on the color information (e.g., RGB data) and depth map (e.g., depth distribution) of the hologram. In addition, a hologram is iteratively generated at a predetermined time interval, and the selected object may include the object that change in at least one of depth and size in an iteratively generated hologram. The selected object may be determined as an object with risk of collision. When it is determined that an additional response is needed, a relevant response process may be requested, or information on the selected object may be delivered to an external apparatus for the relevant response process.

Meanwhile, although not illustrated in FIG. 8, a foveated image generator may further include a memory, which includes random access memory (RAM) and read only memory (ROM), a user interface input device, a user interface output device, a storage, a network interface, and a bus.

Also, there may be one or more processes 801 of FIG. 8, which may be a central processing unit (CPU) or a semiconductor device that processes commands stored in a memory and/or a storage. A memory and a storage may include various types of volatile or non-volatile storage media.

FIG. 9 is a view related to a foveated image generation system according to another embodiment of the present disclosure.

In one embodiment, the foveated image generation system of FIG. 9 may implement the process of FIG. 6 for generating a foveated image or the method of FIG. 7 for generating a foveated image and may include the foveated image generator of FIG. 8. Also, it may include the foveated image generation systems of FIG. 4 and FIG. 5.

In one embodiment, a foveated image generation system 900 may include a hologram generator 901, a precision depth information measuring apparatus 902, and a foveated image generator 903.

Meanwhile, the foveated image generation system of FIG. 9 may be a foveated image generator in another embodiment, and some constituents maybe added or excluded. Some functions of a specific apparatus included in the system of FIG. 9 may be provided by another apparatus.

In one embodiment, the hologram generator 901 may generate a hologram for a front field of view based on input light. Herein, input light may be separated into two optical paths through a wavefront separator and may be used to generate a hologram and also be used for the precision depth information measuring apparatus 902 to measure depth information. A hologram that is generated by the hologram generator 901 may be a hologram that is generated in such a way as self-interference digital holography, and a geometric phase element may be applied.

Meanwhile, a hologram may be iteratively generated at a predetermined time interval. Also, a generated hologram may be a full-color hologram and may be a hologram for a wide field of view or a low-resolution hologram. A generated hologram may be based on complex optical information that is obtained by a single-camera optical system and may be used to distinguish an object including geographic and building information through color information (e.g., RGB) and depth information of hologram. This may be the same as described above with reference to FIGS. 4 to 8. That is, it may be the hologram recording system 401 of FIG. 4 and FIG. 5 but is not limited thereto.

In one embodiment, the precision depth information measuring apparatus 902 may measure depth information of an object to be targeted included in a generated hologram. Herein, a hologram includes what is generated by the hologram generator 901. The precision depth information measuring apparatus 902 may include a ToF camera and/or LiDAR. Based on color information and depth information including a depth distribution of a hologram, depth information of the targeted object(s) may be precisely measured. Meanwhile, as mentioned above, a field of view of a precision depth information measuring apparatus may be adjusted to aim right at a region including the targeted object(s). Meanwhile, the targeted object(s) may be selected from the objects included in a hologram. They may be selected by the foveated image generator 903, and a selection process may be described in further detail below.

In one embodiment, the foveated image generator 903 may distinguish objects included in a generated hologram and select an object(s) to be targeted, for which depth information is to be measured, among the targeted object included in the hologram. Herein, the objects included in the generated hologram are distinguished based on the color information and depth distribution of the hologram, and the depth of the selected object may be precisely measured by the precision depth information measuring apparatus 902. Next, the foveated image generator 903 may generate a foveated image by using depth information of the selected object. As mentioned above, the selected object may exist in a central region of a generated hologram, that is, within a central field of view, or in a peripheral field of view. The selected object may include an object that changes in at least one of depth and size in a hologram (including iteratively generated hologram). Next, the selected object is determined as an object with risk of collision and may request a response process to an external apparatus.

According to the present disclosure, complex optical information may be obtained by using a single-camera optical system and may be utilized as RGB+depth data. As it is the reconstruction of a hologram, a clear image for every depth region may be obtained. Also, it may be used for AR (Augmented Reality) and VR (Virtual Reality) devices, autonomous vehicles and other various areas in which the spatial optical information and RGB information of a periphery needs to be obtained and analyzed.

Accordingly, steps of a method or an algorithm described in relation to embodiments of the present disclosure may be directly implemented by hardware, which is executed by a processor, a software module, or a combination of these two. A software module may reside in a storage medium (that is, a memory and/or a storage) like RAM, flash memory, ROM, EPROM, EEPROM, register, hard disk, removable disk, and CD-ROM. Art exemplary storage medium is coupled with a processor, and the processor may read information from a storage medium and may write information into a storage medium. In another method, a storage medium may be integrated with a processor. A processor and a storage medium may reside in an application-specific integrated circuit (ASIC). An ASIC may reside in a user terminal. In another method, a processor and a storage medium may reside in a user terminal as individual components.

In addition, various embodiments of the present disclosure may be implemented by hardware, firmware, software, or a combination thereof. For implementation by hardware, one or more ASICs (Application Specific Integrated Circuits) DSPs (Digital Signal Processors), DSPDs (Digital Signal Processing Devices), PLDs (Programmable Logic Devices), FPGAs (Field Programmable Gate Arrays), general purpose It may be implemented by a processor (general processor), a controller, a microcontroller, a microprocessor, or the like. For example, it is obvious that it can be implemented in the form of a program stored on a non-transitory computer readable medium that can be used at the end or edge, or a program stored on a non-transitory computer readable medium that can be used at the edge or the cloud. In addition, it can be implemented by a combination of various hardware and software.

Although the exemplary methods of the present disclosure are represented by a series of acts for clarity of explanation, they are not intended to limit the order in which the steps are performed, and if necessary, each step may be performed simultaneously or in a different order. In order to implement a method according to the present disclosure, the illustrative steps may include additional step or exclude some steps while including the remaining steps. Alternatively, some steps may be excluded while additional steps are included.

The scope of the present disclosure is software or machine-executable instructions (e.g., operating systems, applications, firmware, programs, etc.) that allow an operation according to a method of various embodiments to be executed on a device or a computer, and such software or It includes a non-transitory computer-readable medium which stores instructions and the like and is executable on a device or a computer.

For example, a program for generating a foveated image according to an embodiment of the present disclosure may be a program stored in a non-transitory computer-readable medium, which includes: distinguishing objects included in a hologram that is generated for a front field of view by using input light in a computer; measuring, by selecting a targeted object among the distinguished objects, depth information of the targeted object; and generating a foveated image based on the measured depth information and the generated hologram.

The present disclosure described above is capable of various substitutions, modifications, and changes without departing from the technical spirit of the present disclosure for those of ordinary skill in the technical field to which the present disclosure belongs, so the scope of the present disclosure is described above. It is not limited by one embodiment and the accompanying drawings.

What is claimed is:

1. An apparatus for generating a foveated image, the apparatus comprising:
a communicator configured to transmit and receive a signal; and
a processor configured to control the communicator,
wherein the processor distinguishes objects comprised in a hologram, which is generated for a front field of view by using input light, selects an object to be targeted among the distinguished objects, and generates a foveated image by using depth information of the targeted object.

2. The apparatus of claim 1,
wherein the selected object exists in a central region of the generated hologram.

3. The apparatus of claim 1,
wherein the depth information of the selected object is measured through laser-based light detection and ranging (LiDAR) and a time-of-flight (ToF) camera.

4. The apparatus of claim 3,
wherein a field of view of the LiDAR is adjusted to aim a region comprising the selected object.

5. The apparatus of claim 1,
wherein the hologram is based on complex optical information that is obtained by a single-camera optical system.

6. The apparatus of claim 1,
wherein the objects comprised in the generated hologram are distinguished based on a depth map and color information of the hologram.

7. The apparatus of claim 1,
wherein the hologram is iteratively generated, and
wherein the selected object is an object that changes in at least one of depth and size in the iteratively generated hologram.

8. The apparatus of claim 1,
wherein the selected object is determined as an object with risk of collision.

9. The apparatus of claim 1,
wherein the input light is used to generate the hologram and measure the depth information by being separated into two optical paths through a wavefront separator.

10. A method for generating a foveated image, the method comprising:
distinguishing objects comprised in a hologram for a front field of view, which is generated by using input light,
measuring, by selecting an object to be targeted among the distinguished objects, depth information of the selected object; and
generating a foveated image based on the measured depth information and the generated hologram.

11. The method of claim 10,
wherein the selected object exists in a central region of the generated hologram.

12. The method of claim 10,
wherein the depth information of the selected object is measured through laser-based light detection and ranging (LiDAR) and a time-of-flight (ToF) camera.

13. The method of claim 12,
wherein a field of view of the LiDAR is adjusted to aim a region comprising the selected object.

14. The method of claim 10,
wherein the hologram is based on complex optical information that is obtained by a single-camera optical system.

15. The method of claim 10,
wherein the objects comprised in the generated hologram are distinguished based on color information and depth distribution of the hologram.

16. The method of claim 10,
wherein the hologram is iteratively generated, and
wherein the selected object is an object that changes in at least one of depth and size in the iteratively generated hologram.

17. The method of claim 10,
wherein the selected object is determined as an object with risk of collision.

18. The method of claim 10,
wherein the input light is used to generate the hologram and measure the depth information by being separated into two optical paths through a wavefront separator.

19. A system for generating a foveated image, the system comprising:
a hologram generator configured to generate a hologram for a front field of view based on input light;
a precision depth information measuring apparatus configured to measure depth information of an object to be targeted comprised in the hologram; and
a foveated image generator configured to distinguish objects comprised in the generated hologram, to select the object to be targeted for which the depth information is to be measured, and to generate a foveated image by using depth information of the selected object.

20. The system of 19,
wherein the selected object exists in a central region of the generated hologram.
